(19) United States
(12) Patent Application Publication
(10) Pub. No.: US 2026/0303379 A1
(43) Pub. Date: Oct. 1, 2026

(54) BLOCKCHAIN SYNCHRONISATION PROTOCOL

(71) Applicant: nChain Licensing AG, Zug (CH)

(72) Inventors: Alessio PAGANI, London (GB); Craig Steven WRIGHT, London (GB)

(21) Appl. No.: 19/477,758

(22) PCT Filed: Mar. 28, 2024
(86) PCT No.: PCT/EP2024/058485

§ 371 Date: Oct. 22, 2025

(30) Foreign Application Priority Data
Apr. 25, 2023 (GB) 2306027.0

(51) Int. Cl. H04L 9/32; H04L 9/00

(52) U.S. Cl. CPC H04L 9/3297; H04L 9/3247; H04L 9/50

(57) ABSTRACT

A computer-implemented method of determining whether blockchain nodes have a synchronised view of a blockchain, wherein the method is performed by a first blockchain node and comprises: sending i) a first block height corresponding to a most recent block of the blockchain stored by the first blockchain node and ii) a first timestamp corresponding to a current time held by the first blockchain node, to a second blockchain node; receiving i) a second block height corresponding to a most recent block of the blockchain stored by the second blockchain node, and ii) a second timestamp corresponding to a current time held by the second blockchain node, from the second blockchain node; and determining whether the first and second blockchain nodes have a synchronised view of the blockchain based on the first and second block heights and the first and second timestamps.

### CROSS REFERENCE TO RELATED APPLICATIONS

This application is the U.S. National Stage of International Application No. PCT/EP2024/058485 filed on Mar. 28, 2024, which claims the benefit of United Kingdom Patent Application No. 2306027.0, filed on Apr. 25, 2023, the contents of which are all incorporated herein by reference in their entireties.

### TECHNICAL FIELD

The present disclosure relates to a method for blockchain nodes synchronising their view of the blockchain.

### BACKGROUND

Network Time Protocol (NTP) is a protocol which is widely used to synchronize system clocks among a set of distributed time servers and clients. Part of the TCP/IP Suite Application Layer, NTP allows for synchronisation of all the participating devices within a few milliseconds of Coordinated Universal Time. The underlying synchronization algorithm mitigates network latency, reaching an accuracy in the order of one millisecond or less (under ideal conditions). NTP supports both client-server and peer-to-peer architectures.

Clients query NTP servers or other clients at regular intervals, compute their time difference and synchronize accordingly. The client starting the communication synchronises its time with the one receiving the request (i.e. it modifies its local time to synchronise with the receiver).

An NTP packet contains 4 fields, representing 4 timestamps:

| | |
|---|---|
| t0 | Time client initiates packet transmission |
| t1 | Time server receives packet |
| t2 | Time server initiates packet response transmission |
| t3 | Time client receives packet response |

The client fills to, sends the packet to the server that fills t1 and t2 and sends it back to the client that fills t3. At this point the client has the information required to compute the time offset T_{offset}: T_{offset}=((t1−t0)+(t2−t3))/2

If T_{offset} is positive server time is greater than client time, if T_{offset} is negative client time is greater that server time.

The syntonisation algorithm is re-executed at regular intervals, allowing to compute several T_{offset} and filter outliers (e.g. inaccurate times due to temporary bandwidth degradation). The best candidates are used to compute the final time offset, and this estimation is used to gradually adjust the client clock frequency and eliminate the time offset.

Selfish mining is an attack to a blockchain network in which mining nodes (“miners”) obtain a revenue larger than their fair share. According to the Bitcoin white paper, a node should broadcast a block as soon as it finds a valid solution to the hash puzzle. This allows other nodes to verify the block validity, and if accepted, start to build a new block on top of it. A selfish miner instead would withhold a valid block that they have just found, with the result that this miner would have a longer chain than the other nodes. The other nodes in the network continue to build on top of the last published block, while the selfish miner builds on top of the block they found. While the honest nodes continue to build on top of the shared version of the blockchain, the selfish miner would create a private fork with a different set of blocks. If the selfish miner manages to produce more valid blocks than the other nodes (e.g. due to luck or a high hashing power) they can at any time reveal their private chain. As miners are expected to accept as valid the chain with the most accumulated Proof-of-Work, the new valid chain would be the one that was created by the selfish miner.

### SUMMARY

One or more nodes or mining pools can attack the network using the selfish mining technique. This attack creates an unfair advantage for the selfish miners, allowing them to collect more block rewards and transaction fees than expected, and creating a waste of resources for the other nodes that would see the block they found discarded. Moreover, the transactions inserted in the blocks found by the selfish miner may be different from the ones inserted into blocks found by the other nodes. This means that some published transactions may be reversed or be at risk of double spending, creating a waste of resources for the users submitting the transactions to the blockchain network.

It would therefore be desirable to implement a protocol that allows blockchain nodes to prevent or at least mitigate against selfish mining.

Selfish mining can be avoided if network nodes are able to agree on the latest published block at any given time and reach consensus on the next expected block height. As an example, if the majority of the network nodes acknowledge that the latest published block is height x at time to, then the next expected block is x+1. In order to work on block x+2 a node needs to:
1. broadcast block x+1 at t1 (> to).
2. wait for the neighbour nodes (or at least the majority of them) to agree that at time t1 the latest block is height x+1 (i.e. reach consensus) and the next expected block is x+2.

If this approach is followed, a selfish miner cannot create a private fork as a network consensus would always be required to work on a block with a new block height. In other words, a selfish miner that finds a valid block x+1 at time t1 (> to) cannot withhold it and secretly work on block x+2 as the other nodes in the network need to be aware of block x+1 before reaching consensus and expect block x+2.

To achieve this, the blockchain network requires a new consensus mechanism based on two functionalities:
1) A mechanism to synchronise node clocks, creating a common network time.
2) A technique to agree on the latest block height and associate it with the network time.

According to one aspect disclosed herein, there is provided a computer-implemented method of determining whether blockchain nodes have a synchronised view of a blockchain, wherein the method is performed by a first blockchain node and comprises:
sending i) a first block height corresponding to a most recent block of the blockchain stored by the first blockchain node and ii) a first timestamp corresponding to a current time held by the first blockchain node, to a second blockchain node;
receiving i) a second block height corresponding to a most recent block of the blockchain stored by the second blockchain node, and ii) a second timestamp corresponding to a current time held by the second blockchain node, from the second blockchain node; and
determining whether the first and second blockchain nodes have a synchronised view of the blockchain based on the first and second block heights and the first and second timestamps.

According to one aspect disclosed herein, there is provided a computer-implemented method for determining whether blockchain nodes have a synchronised view of a blockchain, wherein the method is performed by a second blockchain node and comprises: receiving i) a first block height corresponding to a most recent block of the blockchain stored by a first blockchain node and ii) a first timestamp corresponding to a current time held by the first blockchain node, from the first blockchain node; and sending i) a second block height corresponding to a most recent block of the blockchain stored by the second blockchain node, and ii) a second timestamp corresponding to a current time held by the second blockchain node, to the first blockchain node.

Embodiments of the present disclosure provide a technique to synchronise the time and block height of two connected blockchain nodes. This technique, or protocol, may referred to as a Blockchain Time and Height Protocol (BTHP). In some embodiments, the BTHP network synchronisation process involves creating a proof (e.g. signed BTHP packets) that a neighbour node is aware of the latest block height known by a given node at a given time. The proofs may act as an alert system to detect selfish mining attacks and an additional criterion to accept/reject a block.

The BTHP allows a node to prove that other nodes knew that at a given time it was using its hashing power to produce a block at a given height. A selfish miner wouldn't be able to provide such proof. Nodes can reject one or more blocks that aim to replace blocks with the same height that they already have, if the block they already have has more signed packets. This may be the case even if the alternative chain is longer, as it would be a proof of a selfish mining attempt.

Overall, the BTHP results in a more synchronised blockchain network, providing a more accurate timestamping service. This may be used as a source of time for devices connecting to the network.

As an illustrative example that uses some embodiments of the present disclosure, a selfish miner may create a chain of blocks and maintain it privately (“a selfish chain”). Meanwhile, other nodes are building an alternative chain, sharing blocks, and agreeing on the current height at a given time using BTHP. The selfish miner decides to attack the network by publishing its version of the blockchain. In the case that the selfish chain has more proof-of-work, the nodes in the network should discard the latest blocks of the blockchain they currently have, replace them with the selfish chain and continue to build on top of that. However, using (signed) BTHP packets, they can detect the attack and reject the blocks of the selfish chain.

As another illustrative example that uses some embodiments of the present disclosure, a portable device with limited resources needs to broadcast a blockchain transaction. It runs a simple blockchain wallet, but the hardware and software have limited capabilities. For example, there is no internal clock or no network level protocols can be executed to synchronise its clock (e.g. it cannot run NTP to synchronise their time with internet severs). While broadcasting the transaction, the device may request the current time from a blockchain node and synchronise its clock with the blockchain clock. Additionally or alternatively, the device may request the current block height from the blockchain node to ensure that it has an up-to-date view of the blockchain. This is useful for, amongst other things, avoiding double-spend attempts.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain, and

FIG. 3 is a schematic block diagram of a system for implementing a synchronisation protocol.

### DETAILED DESCRIPTION OF EMBODIMENTS

### 1. Blockchain Synchronisation Protocol

Embodiments of the present disclosure enable blockchain nodes 104 to determine whether they have a synchronised view of the blockchain, or put another way, whether they have an up-to-date view of the blockchain. Here, blockchain nodes 104 are synchronised if the blockchains nodes 104 have access to the same blocks. More specifically, embodiments enable nodes 104 to determine whether they have the same view of the latest (i.e. most recently published) block.

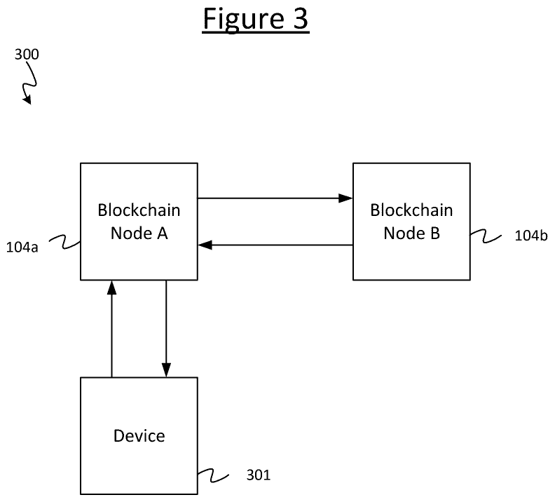

FIG. 3 illustrates an example system 300 for implementing the described embodiments. This example system 300 includes first and second blockchain nodes 104a, 104b and an end device 301. The end device 301 may be a low-powered device such as an loT device. It will be appreciated that in general the system 300 may include any number of blockchain nodes 104 and any number of end devices 301. The end devices need not be the same type of device.

A first blockchain node (“Node A”) 104a initiates the synchronisation protocol by sending, to a second blockchain node (“Node B”) 104b, the block height of the latest block available to (i.e. stored by) the first blockchain node 104a. Node A 104a also sends a current timestamp to Node B 104b. The timestamp may take any suitable form. It may include only the time, or both the date and time. The timestamp and block height together provide Node A's current view of the blockchain 150. That is, according to Node A 104a, at time to the blockchain is formed of b0 blocks.

Node A 104a may send the same data (timestamp and block height) to one or more additional blockchain nodes 104. The data may be sent as part of a synchronisation request.

Upon receipt of the timestamp and block height from Node A 104a, Node B returns the block height of the latest block available to (i.e. stored by) Node B 104a. Node B 104b also sends a current timestamp to Node A 104a. The timestamp and block height together provide Node B's current view of the blockchain 150. That is, according to Node B 104b, at time t1 the blockchain 150 is formed of b1 blocks.

Node A 104a uses its own timestamp and block height and the timestamp and block height received from Node B 104b to determine whether it has the same view of the blockchain 150 as Node B 104b, i.e. whether node A 104a and node B 104b are synchronised. For instance, Node Aa 104 may determine that it has the same view of the blockchain 150 if the sent and received block heights are the same. In some examples, the timestamps must also be the same, or within a predetermined threshold.

If the block height received from Node B 104b is greater than Node A's block height, it means that Node B 104b has access to one or more additional blocks compared to Node A 104a. In this case, Node A 104a may request the additional block(s) from Node B 104b so as to synchronise with Node B 104b.

On the other hand, if the block height received from Node B 104b is less than Node A's block height, it means that Node A 104a has access to one or more additional blocks compared to Node B 104b. In this case, Node A 104a may send the additional block(s) to Node B 104b, or at least notify B 104b that it has access to the additional block(s). Node A 104a may then send the block(s) if Node B 104b requests.

In some examples, Node A 104a may determine that its clock is synchronised with Node B 104b if the sent and received timestamps are the same, or within a predetermined threshold. For example, Node A 104a may determine a time offset (i.e. a difference) between Node A's timestamp and Node B's timestamp, and if the time offset is less than the predetermined threshold (i.e. less than a predetermined amount), then the nodes 104 may be said to have a synchronised time view. If the time offset is more than the threshold, node A 104a may update its time based on the time offset, i.e. by adding or subtracting the time offset to or from the Node A's clock.

Node A 104a may, when publishing a new block to the blockchain 150, include a current timestamp. In some examples, the current timestamp is the updated time after Node A 104a has updated its clock based on the time offset.

If Node A 104a determines that it has the same view of the blockchain 150 as Node 104b in terms of block height, Node A 104a may sign a message attesting to having the same view, and send the signed message to Node B 104b. Similarly, if Node A 104a determines that it has the same time as Node 104b, Node A 104a may sign a message attesting to having the same time, and send the signed message to Node B 104b. In some examples, a single message may attest to having the same view as the blockchain and the same time.

In some examples, after receiving Node B's block height and timestamp, Node A 104a may send a message to Node B 104 including an updated timestamp (i.e. a timestamp corresponding to a current time) and an updated block height corresponding to the latest block available to (i.e. stored by) Node A 104a. In some examples, the block available to Node A 104a may be a new block compared to the latest block available to Node A 104a at the time of sending the initial block height.

As an example, Node A 104a may first send a message to Node B 104b that includes the initial timestamp and block height. Node B 104b may update the message by including its timestamp and block height, and return the message to Node A 104a. Node A 104a, if it determines it is synchronised with Node B 104b, may include the updated timestamp and block height in the message, sign the message, and return the signed message to Node B 104b.

An equivalent process may be performed by an end device 301. That is, rather than the interaction being between two nodes 104, the interaction may instead be between a node 104 and a device. In practice the process is likely to be initiated by the end device 301 rather than the node 104, but the alternative is also an option. The end device 301 may perform this process to obtain an updated version of the blockchain 150 and the current time.

The following describes a specific example of the protocol described above which is based on NTP, and that allows for blockchain nodes 104 to synchronise their time and block height. This protocol, referred to herein as Blockchain Time and Height Protocol or BTHP, is a protocol that works peer-to-peer (i.e. node-to-node) to synchronise network time and block height. Nodes 104 may still use NTP to synchronise their time with high-precision timekeeping devices or servers (e.g. Stratum 0 or 1). When implemented by network nodes 104, BTHP:
improves the accuracy of the blockchain 150 as a timestamping service, and.
helps to prevent selfish mining attacks.

A process of network synchronisation (BTHP network synchronisation) may be used to ensure two nodes 104 have the same time and the same blockchain height. A node 104 may use this synchronisation algorithm with one, some or every neighbour node 104 to make sure they are synchronised. This technique uses a variation of the existing NTP where, along with the time, the current block height is also shared. Moreover, BTHP may be executed at the node software level (e.g. as an RPC call) instead of system level (i.e. TCP/IP Application Layer), allowing nodes 104 to synchronise time independent of the operating system. The time and height synchronisation may be achieved through the exchange of specific packets, that are referred to herein as BTHP packets.

A BTHP packet contains the same fields of an NTP packet, with the addition of the block height in the first part of the handshake: b0 represents the latest block height of the blockchain stored by the node 104 starting the synchronization request (node A), while b1 represents the latest block height of the blockchain stored by the node receiving the synchronisation request (node B). At the end of the synchronisation process, nodes 104 may show acceptance of time and block height by signing a copy of the BTHP packet and sending it to the other node 104.

An example BTHP packet is as follows:

TABLE 1
BTHP packet structure

| | |
|---|---|
| t0 | Time node A initiates packet transmission |
| b0 | Latest block height known by node A at time t0 |
| t1 | Time node B receives packet |
| b1 | Latest block height known by node B at time t1 |
| t2 | Time node B initiates packet response transmission |
| t3 | Time node A receives packet response |
| Signature | Signature from node A or node B |

If a network node, node A, wants to synchronise its time and block height with a neighbour node, node B, it may execute the BTHP network synchronisation exchanging a BTHP packet, as follows:
1. node A creates a new BTHP packet and fills t0 and b0
2. node A sends the BTHP packet to node B
3. node B receives the packet and fills t1, b1
4. node B fills t2 when it is ready to retransmit and sends the packet back to node A
5. node A receives the packet and fills t3.

Once the exchange is complete, there are 3 possible scenarios:
If b0 is equal to b1 it means that nodes A and B have the same block height. The time offset T_{offset} is computed using the same formulas used in NTP and any offset is adjusted. If the offset is below a predefined threshold, the two nodes 104 may sign the packet to show acceptance of height and time. Otherwise the BTHP network synchronisation process is repeated after the node 104 has adjusted is clock to make sure there is an agreement on time (within the offset) and block height.
If b0 is lower than b1, node B is 1 or more blocks ahead of node A. Node A asks for the missing blocks and re-execute the BTHP network synchronisation process.
If b0 is greater than b1, node A is 1 or more blocks ahead of node B. The process is interrupted because node B's blockchain view is not updated. Optionally, node A can notify node B of the missing blocks or transfer them.

Node A may re-execute the BTHP network synchronisation process with one or more neighbour nodes 104. Furthermore, node A may re-execute the BTHP network synchronisation process at regular intervals and/or when it updates the block time in the header of the candidate block for publication.

If two nodes 104 are synchronised both in terms of time (within a predefined threshold) and block height, node A signs the packet and sends it to node B. Likewise, if node B agrees with the time and block height, it may sign another copy of the BTHP packet and send it back to node A. Optionally, the nodes 104 may update the time in the block header of the block being produced to improve the accuracy of the blockchain 150 as a timestamping service. The predefined time threshold may be agreed among the nodes 104, or it may be a parameter of the blockchain node software.

If this process is repeated with several neighbour nodes 104, when a node A finds a valid block, it can prove that other nodes 104 knew that it was mining a block with a given height at a given time. Similarly, this node 104 can prove that other nodes 104 agreed that they were trying to find a valid block with the same height, detecting the creation of private forks (with a higher height than agreed) and, therefore, preventing selfish mining.

As an example, suppose there is a simple network with 4 nodes A, B, C and D: 3 network nodes (A, B and C) use BTHP to synchronise their time and height. If a selfish miner (D) publishes a longer chain (i.e. with a higher block height), nodes A, B and C would immediately notice that the blocks in their current version of the blockchain are created by nodes with BTHP signed packets, while the new blocks are all published by one (or more) nodes without such packets. BTHP packets act as a proof that (at least) these network nodes 104 reached consensus on a block height at a given time. They may request signed BTHP packets from node D to verify that it is acting honestly before replacing the existing blocks. If they are not convinced of the honesty of node D, they can eventually decide to reject them.

This technique may be used to improve the block acceptance policy of the network nodes 104. For example, a block may be considered valid only if, in addition to a valid proof of work, also one or more signed BTHP packets are provided (proof of time and block height). A less strict policy may allow for any valid block to be accepted, but a block without enough signed BTHP packets cannot replace an existing published chain of blocks (this would be enough to prevent selfish mining). In a lighter version, that doesn't involve any change in the block acceptance rules, this technique may be used as an alert system to identify possible selfish mining attacks and the signed BTHP packets (or lack of) may be used as a proof of attack and as a way to identify the honest chain (which has signed BTHP packets).

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

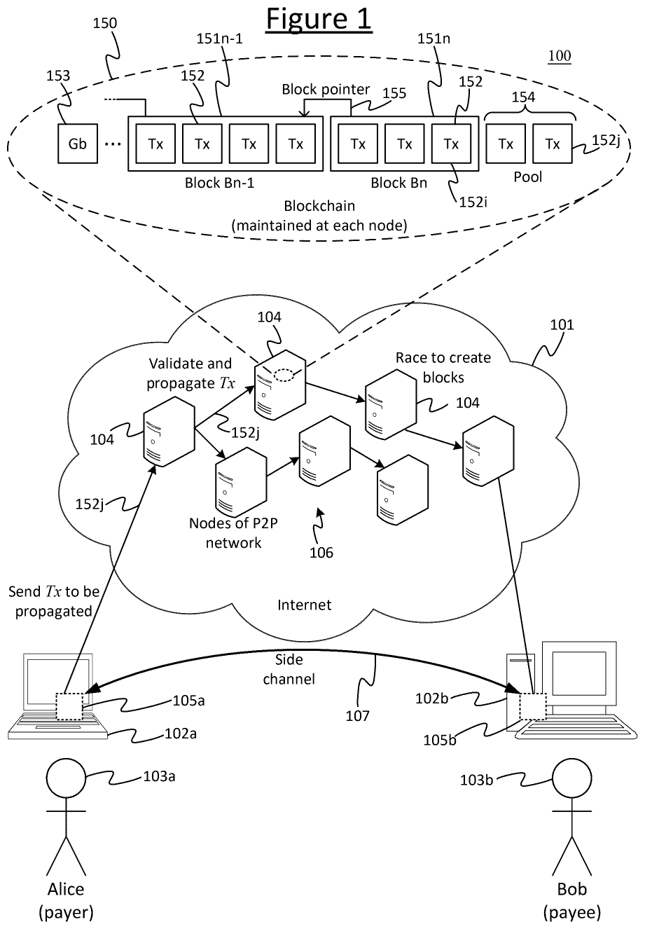

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

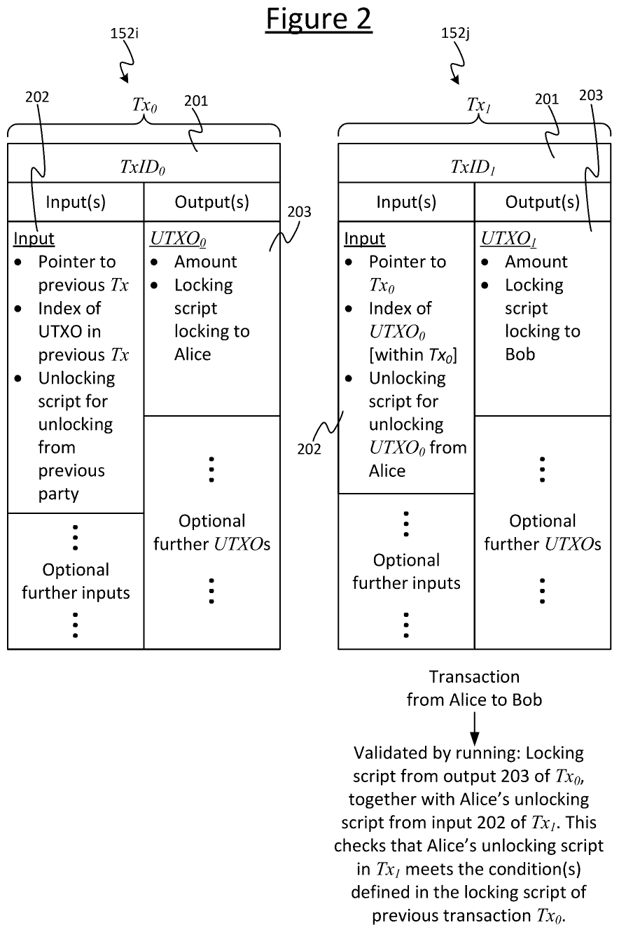

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of determining whether blockchain nodes have a synchronised view of a blockchain, wherein the method is performed by a first blockchain node and comprises:
sending i) a first block height corresponding to a most recent block of the blockchain stored by the first blockchain node and ii) a first timestamp corresponding to a current time held by the first blockchain node, to a second blockchain node;
receiving i) a second block height corresponding to a most recent block of the blockchain stored by the second blockchain node, and ii) a second timestamp corresponding to a current time held by the second blockchain node, from the second blockchain node; and
determining whether the first and second blockchain nodes have a synchronised view of the blockchain based on the first and second block heights and the first and second timestamps.

Statement 2. The method of statement 1, comprising, if the first block height is less than the second block height:
determining that the second blockchain node's view of the blockchain differs by one or more blocks; and
requesting the one or more blocks from the second blockchain node.

Statement 3. The method of statement 1 or statement 2, comprising, if the first block height is greater than the second block height:
determining that the first blockchain node's view of the blockchain differs by one or more blocks; and
notifying the second blockchain node that the second blockchain node is missing the one or more blocks and/or sending the one or more blocks to the second blockchain node.

Statement 4. The method of any preceding statement, comprising:
determining a time offset between the first timestamp and the second timestamp; and
determining whether the first and second blockchain nodes have a synchronised view of the time based on the time offset.

Statement 5. The method of statement 4, comprising, if the time offset is larger than a predetermined threshold, updating a current time of the first blockchain node based on the time offset.

Statement 6. The method of statement 5, wherein said updating is performed whilst producing a new block of the blockchain, and wherein the method comprises updating a timestamp included in the new block with the updated current time.

Statement 7. The method of any preceding statement, comprising:
determining that the first and second blockchain nodes have a synchronised view of the blockchain;
signing a first message indicating that the first and second blockchain nodes have a synchronised view of the blockchain; and
sending the signed first message to the second blockchain node.

Statement 8. The method of statement 4 or any statement dependent thereon, comprising:
determining that the first and second blockchain nodes have a synchronised view of the time;
signing a second message indicating that the first and second blockchain nodes have a synchronised view of the time; and
sending the signed second message to the second blockchain node.

Statement 9. The method of statement 7 and statement 8, wherein the first and second messages are the same.

Statement 10. The method of any preceding statement, wherein said sending of the first block height and first timestamp comprises sending a message comprising the first block height and the first timestamp to the second blockchain node, wherein the second blockchain node is configured to update the message to include a third timestamp corresponding to a time of receipt of the message by the second blockchain node, the second block height and the second timestamp, and wherein said receiving of the second block height and the second timestamp comprises receiving the message from the second blockchain node.

Statement 11. The method of statement 9 and statement 10, comprising:
updating the message to include a fourth timestamp corresponding to a time of receipt of the message by the first blockchain node;
signing the message; and
sending the signed message to the second blockchain node.

Statement 12. The method of statement 9 and statement 11, wherein the message is the first message.

Statement 13. The method of statement 11 or statement 12, comprising:
publishing a new block to the blockchain, wherein the new block comprises the signed message.

Statement 14. The method of any preceding statement, comprising:
receiving a request from a requesting device for a current time and/or current block height; and
sending the current time and/or the current block height to the requesting device.

Statement 15. The method of statement 7, comprising:
detecting a target block published by the second blockchain node, wherein the target block is associated with a target block height greater than the second block height and/or wherein the target block does not comprise the signed first message; and
performing one or more of the following;
determining that the second blockchain node is performing a process of selfish mining,
sending an alert to one or more blockchain nodes,
rejecting the target block.

Statement 16. A computer-implemented method for determining whether blockchain nodes have a synchronised view of a blockchain, wherein the method is performed by a second blockchain node and comprises:
receiving i) a first block height corresponding to a most recent block of the blockchain stored by a first blockchain node and ii) a first timestamp corresponding to a current time held by the first blockchain node, from the first blockchain node; and
sending i) a second block height corresponding to a most recent block of the blockchain stored by the second blockchain node, and ii) a second timestamp corresponding to a current time held by the second blockchain node, to the first blockchain node.

Statement 17. The method of statement 16, comprising:
receiving a request for one or more blocks from the first blockchain node; and
sending the one or more blocks to the first blockchain node.

Statement 18. The method of statement 16 or statement 17, comprising:
receiving a notification from the first blockchain node that the second blockchain node is missing one or more blocks and/or receiving the one or more blocks from the first blockchain node.

Statement 19. The method of statement 16 or any statement dependent thereon, comprising:
receiving a signed first message indicating that the first and second blockchain nodes have a synchronised view of the blockchain;
determining that the first and second blockchain nodes have a synchronised view of the blockchain;
signing the first signed message; and
sending the signed first message to the first blockchain node.

Statement 20. The method of statement 16 or any statement dependent thereon, comprising:
receiving a signed second message indicating that the first and second blockchain nodes have a synchronised view of the time;
determining that the first and second blockchain nodes have a synchronised view of the time;
signing the second signed message; and
sending the signed second message to the first blockchain node.

Statement 21. The method of statement 16 or any statement dependent thereon, wherein said receiving of the first block height and first timestamp comprises receiving a message comprising the first block height and the first timestamp from the first blockchain node, and wherein the method comprises:
updating the message to include a third timestamp corresponding to a time of receipt of the message by the second blockchain node, the second block height and the second timestamp, and wherein said sending of the second block height and the second timestamp comprises sending the updated message to the first blockchain node.

Statement 22. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 21.

Statement 23. A computer program embodied on computer-readable storage and configured so as, when run on one or more processors, to perform the method of any of statements 1 to 21.

According to another aspect disclosed herein, there may be provided a method comprising the actions of the first and second blockchain nodes. According to another aspect disclosed herein, there may be provided a system comprising the computer equipment of the first and second blockchain nodes.

According to another aspect disclosed herein, there may be provided a method comprising the actions of the end device and one or both of the first and second blockchain nodes. According to another aspect disclosed herein, there may be provided a system comprising the computer equipment of the end device and one or both of the first and second blockchain nodes.

1. A computer-implemented method of determining whether blockchain nodes have a synchronised view of a blockchain, wherein the method is performed by a first blockchain node and comprises:
sending i) a first block height corresponding to a most recent block of the blockchain stored by the first blockchain node and ii) a first timestamp corresponding to a current time held by the first blockchain node, to a second blockchain node, wherein the first block height and the first timestamp are comprised in a single first message;
receiving i) a second block height corresponding to a most recent block of the blockchain stored by the second blockchain node, and ii) a second timestamp corresponding to a current time held by the second blockchain node, from the second blockchain node, wherein the second block height and the second timestamp are comprised in a single second message; and
determining whether the first and second blockchain nodes have a synchronised view of the blockchain based on the first and second block heights and the first and second timestamps.

2. The method of claim 1, comprising, when the first block height is less than the second block height:
determining that the second blockchain node's view of the blockchain differs by one or more blocks; and
requesting the one or more blocks from the second blockchain node.

3. The method of claim 1, comprising, when the first block height is greater than the second block height:
determining that the first blockchain node's view of the blockchain differs by one or more blocks; and
notifying the second blockchain node that the second blockchain node is missing the one or more blocks and/or sending the one or more blocks to the second blockchain node.

4. The method of claim 1, comprising:
determining a time offset between the first timestamp and the second timestamp; and
determining whether the first and second blockchain nodes have a synchronised view of the time based on the time offset.

5. The method of claim 4, comprising, if the time offset is larger than a predetermined threshold, updating a current time of the first blockchain node based on the time offset.

6. The method of claim 5, wherein said updating is performed whilst producing a new block of the blockchain, and wherein the method comprises updating a timestamp included in the new block with the updated current time.

7. The method of claim 1, comprising:
determining that the first and second blockchain nodes have a synchronised view of the blockchain;
signing a first message indicating that the first and second blockchain nodes have a synchronised view of the blockchain; and
sending the signed first message to the second blockchain node.

8. The method of claim 4, comprising:
determining that the first and second blockchain nodes have a synchronised view of the time;
signing a second message indicating that the first and second blockchain nodes have a synchronised view of the time; and
sending the signed second message to the second blockchain node.

9. The method of claim 7, wherein the first and second messages are the same, and wherein the method comprises:
determining that the first and second blockchain nodes have a synchronised view of the time;
signing a second message indicating that the first and second blockchain nodes have a synchronised view of the time; and
sending the signed second message to the second blockchain node.

10. The method of claim 1, wherein said sending of the first block height and first timestamp comprises sending a message comprising the first block height and the first timestamp to the second blockchain node, wherein the second blockchain node is configured to update the message to include a third timestamp corresponding to a time of receipt of the message by the second blockchain node, the second block height and the second timestamp, and wherein said receiving of the second block height and the second timestamp comprises receiving the message from the second blockchain node.

11. The method of claim 9, wherein said sending of the first block height and first timestamp comprises sending a message comprising the first block height and the first timestamp to the second blockchain node, wherein the second blockchain node is configured to update the message to include a third timestamp corresponding to a time of receipt of the message by the second blockchain node, the second block height and the second timestamp, and wherein said receiving of the second block height and the second timestamp comprises receiving the message from the second blockchain node, and wherein the method comprises:
updating the message to include a fourth timestamp corresponding to a time of receipt of the message by the first blockchain node;
signing the message; and
sending the signed message to the second blockchain node.

12. The method of claim 11, wherein the message is the first message.

13. The method of claim 12, comprising:
publishing a new block to the blockchain, wherein the new block comprises the signed message.

14. The method of claim 1, comprising:
receiving a request from a requesting device for a current time and/or current block height; and
sending the current time and/or the current block height to the requesting device.

15. The method of claim 7, comprising:
detecting a target block published by the second blockchain node, wherein the target block is associated with a target block height greater than the second block height and/or wherein the target block does not comprise the signed first message; and
performing one or more of the following;
determining that the second blockchain node is performing a process of selfish mining,
sending an alert to one or more blockchain nodes,
rejecting the target block.

16. A computer-implemented method for determining whether blockchain nodes have a synchronised view of a blockchain, wherein the method is performed by a second blockchain node and comprises:
receiving i) a first block height corresponding to a most recent block of the blockchain stored by a first blockchain node and ii) a first timestamp corresponding to a current time held by the first blockchain node, from the first blockchain node, wherein the first block height and the first timestamp are comprised in a single first message; and
sending i) a second block height corresponding to a most recent block of the blockchain stored by the second blockchain node, and ii) a second timestamp corresponding to a current time held by the second blockchain node, to the first blockchain node, wherein the second block height and the second timestamp are comprised in a single second message.

17-18. (canceled)

19. The method of claim 16, comprising:
receiving a signed first message indicating that the first and second blockchain nodes have a synchronised view of the blockchain;
determining that the first and second blockchain nodes have a synchronised view of the blockchain;
signing the first signed message; and
sending the signed first message to the first blockchain node.

20. The method of claim 16, comprising:
receiving a signed second message indicating that the first and second blockchain nodes have a synchronised view of the time;
determining that the first and second blockchain nodes have a synchronised view of the time;
signing the second signed message; and
sending the signed second message to the first blockchain node.

21. The method of claim 16, wherein said receiving of the first block height and first timestamp comprises receiving a message comprising the first block height and the first timestamp from the first blockchain node, and wherein the method comprises:
updating the message to include a third timestamp corresponding to a time of receipt of the message by the second blockchain node, the second block height and the second timestamp, and wherein said sending of the second block height and the second timestamp comprises sending the updated message to the first blockchain node.

22. (canceled)

23. A computer program embodied on non-transitory computer-readable storage media and configured so as, when run on one or more processors, to perform a method of determining whether blockchain nodes have a synchronised view of a blockchain, wherein the method is performed by a first blockchain node and comprises:
sending i) a first block height corresponding to a most recent block of the blockchain stored by the first blockchain node and ii) a first timestamp corresponding to a current time held by the first blockchain node, to a second blockchain node, wherein the first block height and the first timestamp are comprised in a single first message;
receiving i) a second block height corresponding to a most recent block of the blockchain stored by the second blockchain node, and ii) a second timestamp corresponding to a current time held by the second blockchain node, from the second blockchain node, wherein the second block height and the second timestamp are comprised in a single second message; and
determining whether the first and second blockchain nodes have a synchronised view of the blockchain based on the first and second block heights and the first and second timestamps.

24. (canceled)
